(19) United States
(12) Patent Application Publication
(10) Pub. No.: US 2026/0212288 A1
(43) Pub. Date: Jul. 23, 2026

(54) WORKFLOW MANAGEMENT

(71) Applicant: Honeywell International Inc., Charlotte, NC (US)

(72) Inventors: Ankit Singh, Apex, NC (US); Derek Grzyb, Milltown, NJ (US); Lakshminarayana Paila, Frisco, TX (US); Rayon Watson, Ocean Township, NJ (US)

(73) Assignee: Honeywell International Inc., Charlotte, NC (US)

(21) Appl. No.: 19/034,663

(22) Filed: Jan. 23, 2025

(51) Int. Cl. G06Q 10/0631; G06F 40/194; G06F 40/205; G06F 40/30; G06Q 10/0633

(52) U.S. Cl. CPC G06Q 10/06311; G06F 40/194; G06F 40/205; G06F 40/30; G06Q 10/0633

(57) ABSTRACT

Approaches for workflow management process are described. According to one example, a plurality of workflow phases is configured for the workflow management process. For each of the plurality of workflow phases, at least one prespecified workflow object and a workflow object identifier for the at least one prespecified workflow object are obtained. The at least one prespecified workflow object is to implement a respective workflow phase from among the plurality of workflow phases. Further, the at least one prespecified workflow object is stored for implementation in the workflow management process when a proximity of the at least one prespecified workflow object with each workflow phase of the plurality of workflow phases is within a prespecified threshold or a similarity coefficient between semantics of the workflow object identifier and semantics of each workflow phase are between the semantics.

### BACKGROUND

Workflow management processes, in general, are processes used in various industries to streamline operations, improve efficiency, and ensure consistency in executing complex tasks. The workflow management processes may involve multiple workflow phases, each requiring specific actions to be performed. Each of the workflow phases may include specific models to accomplish certain actions for the workflow process. For instance, a recall management is a process of recalling products that are may be defective or potentially defective, risky for health, from the market. A recall management process may include multiple phases such a pre-recall, recall, post-recall. Each phase may involve multiple steps. For e.g., recall phase may involve problem identification phase, risk assessment phase, decision phase etc.

Such workflow management processes, hereinafter may also be referred to as workflow management tool, may be used by users to automate repetitive tasks, reducing manual efforts. Further, the user may obtain a clear overview of the workflow, track status of different tasks, issue detection etc.

### SUMMARY OF INVENTION

This summary is provided to introduce concepts related to workflow management. This summary is not intended to identify essential features of the claimed subject matter nor is it intended for use in determining or limiting the scope of the claimed subject matter.

In an aspect of the present subject matter, a system for workflow management is disclosed. The system may include a workflow assigning engine. The workflow assigning engine may obtain a workflow object identifier for at least one prespecified workflow object for each of a plurality of workflow phases. The at least one prespecified workflow object is to implement a respective workflow phase from among the plurality of workflow phases in a workflow management process. The workflow assigning engine may obtain semantics of the workflow object identifier and semantics of each of the plurality of workflow phases. The workflow assigning engine may parse the semantics of the workflow object identifier and the semantics of each of the plurality of workflow phases through a workflow assigning model to determine a similarity coefficient between semantics of the at least one prespecified workflow object and the semantics of each of the plurality of workflow phases. The workflow assigning engine may obtain the at least one prespecified workflow object to be executed for one or more of the plurality of workflow phases having the similarity coefficient between the semantics. The workflow assigning engine may store the at least one prespecified workflow object for implementing the one or more of the plurality of workflow phases during the workflow management process. The at least one prespecified workflow object is to be fetched while initiating the workflow management process.

In another aspect of the present subject matter, a method for workflow management is disclosed. The method may comprise obtaining configuring a plurality of workflow phases in a workflow management process. The at least one prespecified workflow object may be obtained from a plurality of workflow datasets for each of the plurality of workflow phases. The at least one prespecified workflow object is to implement a respective workflow phase from among the plurality of workflow phases in the workflow management process. The method may further comprise determining proximity of the at least one prespecified workflow object with each of the plurality of workflow phases. On determining the proximity between the at least one prespecified workflow object and one or more of the plurality of workflow phases in a prespecified threshold, the at least one prespecified workflow object to be executed for the one or more of the plurality of workflow phases having the proximity in the prespecified threshold may be obtained. The at least one prespecified workflow object may be stored for implementation of a respective workflow phase from among the plurality of workflow phases. The at least one prespecified workflow object is to be fetched while initiating the workflow management process.

In yet another aspect of the present subject matter, a non-transitory computer readable medium for workflow management is disclosed. The non-transitory computer readable medium has instructions stored thereon. The instructions, when executed by a processing resource, cause the processing resource to perform operations. In the operations, a workflow object identifier may be obtained for at least one prespecified workflow object for each of a plurality of workflow phases of a workflow management process. The at least one prespecified workflow object is to implement a respective workflow phase from among the plurality of workflow phases. Further, in the operations, proximity of the at least one prespecified workflow object with each workflow phase of the plurality of workflow phases may be determined; or a similarity coefficient between semantics of the workflow object identifier and semantics of each workflow phase may be determined. The at least one prespecified workflow object to be executed for one or more workflow phases, from among the plurality of workflow phases may be obtained, having one of, the proximity in a prespecified threshold and the similarity coefficient between the semantics. In the operations, the at least one prespecified workflow object for implementation in the workflow management process may be stored. The at least one prespecified workflow object is to be fetched while initiating the workflow management process.

### BRIEF DESCRIPTION OF FIGURES

Systems and/or methods are now described, in accordance with examples of the present subject matter and with reference to the accompanying figures, in which:

FIG. 1 illustrates a system for workflow management, according to an example;

FIG. 2 illustrates a communication environment implementing a system for workflow management, according to another example;

FIG. 3 illustrates a schematic representation of a user interface as per a first layout, according to an example;

FIG. 4 illustrates a schematic representation of a user interface as per a second layout, according to another example;

FIG. 5 illustrates a method for implementation of workflow management, according to an example;

FIG. 6 illustrates configuring of a plurality of workflow phases in a workflow management process, according to an example;

FIG. 7 illustrates determining proximity of a prespecified workflow object from one or more workflow phases in a workflow management process, according to an example;

FIG. 8 illustrates a method for implementation of workflow management, according to another example, and

FIG. 9 illustrates a computing environment implementing a non-transitory computer-readable medium for a workflow management process, according to an example.

### DETAILED DESCRIPTION

Conventional workflow management systems implementing workflow management processes may rely on manual configuration and assignment of tasks, data sources, and objects to different phases of a workflow. For example, for a recall management process, a business administrator may manually determine appropriate data models, objects, and systems of record for each workflow phase of the recall management process based on the character of the phases involved in the recall management process, the users involved, and the actions required at each phase. However, this approach may be time-consuming, error-prone, and may not always result in optimal resource allocation. The manual nature of the approach may also lead to inefficiencies, particularly in large-scale operations or when dealing with complex workflows that involve multiple data sources and systems. Additionally, as workflows evolve or new requirements emerge, the manual reconfiguration of these systems may become a significant burden on administrative resources. The increase in the volume and variety of data available to organizations present challenges in workflow management due to the increase in the complexity of the data management within workflow systems.

In conventional workflow management systems, workflow objects containing information of the workflow are obtained. Examples of workflow objects may include, but not limited to, set of actions, events, decision point, files, records, reports, and product information. These workflow objects may be fetched from an external database or external server referred to as workflow datasets hereinafter. At the initiation of each phase, the workflow objects are firstly loaded in the workflow management system. The loading of the workflow objects may be a time-consuming process. As a result, the efficiency of the workflow management process reduces. For example, a recall management process for an inventory may include various phases such as quality investigation phase, recall investigation phase, recall execution phase. At the initiation of each phase, workflow objects that are associated with the respective phase may be obtained from a plurality of workflow datasets. As a result, the user may have to wait each time a new phase is initiated for the workflow objects to be obtained.

The present subject matter describes approaches for automatic assigning of workflow objects to a plurality of workflow phases in a workflow management process. According to an implementation of the present subject matter, an initial phase is configured in a user interface to set up a plurality of workflow phases in a workflow management process. In an example, the workflow management process may be a recall management process for recalling certain specific products from a market such as defected products. For example, the plurality of workflow phases of the recall management process may include an initial phase, a recall investigation phase, and a recall execution phase. In an example, during the configuration of the initial phase, the plurality of workflow phases may be generated in the user interface, for example, using a dropdown menu. In an example, for each of the plurality of workflow phases, a plurality of workflow datasets may be assigned. The plurality of workflow datasets may include a prespecified workflow object that is to implement a respective workflow phase of the workflow process. Examples of workflow objects may include, but are not limited to, set of actions, events, decision point, files, records, reports, and product information. In an example, the plurality of workflow datasets may be stored in one or more workflow repositories as workflow object data. For example, a financial dataset may include information related to cost price and selling price of one or more products in an inventory. During the initial phase, the one prespecified workflow object for each of the plurality of workflow phases are obtained from a plurality of workflow datasets.

Once the initial phase is configured, a workflow object identifier for a prespecified workflow object for each of one or more workflow phases is obtained. Examples of the workflow object identifier may include, but are not limited to, workflow object name, workflow object type, workflow object number, date of creation of workflow object, date of modification of workflow object. In an example, upon obtaining the workflow object identifier, semantics of the workflow object identifier and the semantics of each of the plurality of workflow phases are obtained. In an example, semantics may be obtained using semantic annotations approach.

In an example, the semantics of the workflow object identifier and the semantics of each of the plurality of workflow phases are parsed through a workflow assigning model to determine a similarity coefficient between semantics of the prespecified workflow object and the semantics of each of the plurality of workflow phases. In an example, the workflow assigning model may be an open artificial intelligence-based model. In an example, the workflow assigning model may be k-means clustering model. In an example, the parsing of the semantics may comprise transforming context of the prespecified workflow object and context of each of the plurality of workflow phases to a high-dimensional vector representing semantic and syntactic characteristics of the contexts. Further, the high-dimensional vector is parsed through a vector space of the workflow assigning model for searching vector embeddings in the vector space close to the high-dimensional vector. In an example, each prespecified workflow object having similarity coefficient between the semantics is obtained. For example, similarity coefficient may be obtained based on the semantics of the workflow object name and the each of the plurality of workflow phases by parsing the semantics through the workflow assigning model. In the workflow assigning model, the semantics may be compared using k-means clustering approach to determine the similarity coefficient. For each of the plurality of workflow phases, a prespecified workflow object having the similarity coefficient between the semantics is obtained. The prespecified workflow object is stored for implementing the one or more of the plurality of workflow phases during the workflow management process. The stored prespecified workflow object is to be fetched while initiating the workflow management process.

By storing the prespecified workflow object having the similarity coefficient between the semantics, each of the workflow phase upon implementing may have the prespecified workflow object ready to be executed during the implementation of the workflow phase. For example, by storing the prespecified workflow object having the similarity coefficient between the semantics of the object name and the plurality of workflow phases, the object for the recall investigation phase and the recall execution phase may be prestored in the system. As a result, when the phases, i.e., the recall investigation phase is initiated, the workflow objects having similarity coefficient between the semantics of the object name and the semantics of the recall investigation phase, may already be loaded. Similarly, when the recall execution phase is initiated, the workflow objects having similarity coefficient between the semantics of the object name and the semantics of the recall execution phase, may already be loaded. As a result, the time-consumption in loading the desired workflow objects at the beginning of the workflow phases is reduced. The user may immediately be able to execute the workflow phase and quickly complete the workflow management process. Therefore, the efficiency of the workflow management process can be improved.

In another implementation of the present subject matter, the workflow phases in a workflow management process are configured. Once the workflow phases are configured, a prespecified workflow object is obtained from a plurality of workflow datasets for each of the workflow phases. Further, proximity of the prespecified workflow object is determined with each of the workflow phases is determined to be within a prespecified threshold. In an example, a workflow object metadata associated with the prespecified workflow object and a workflow phase metadata for each of the one or more of the plurality of workflow phases are generated. In an example, metadata describes meanings of the workflow object and the workflow phase. In an example, the workflow object metadata with the workflow phase metadata for each of the one or more of the plurality of workflow phases are compared to determine the proximity of the prespecified workflow object with each of the plurality of workflow phases. When it is determined that the proximity is within the prespecified threshold, the prespecified workflow object having the proximity in the prespecified threshold is obtained. In an example, the prespecified workflow object is stored for implementation of a respective workflow phase from among the workflow phases in the workflow management process. The stored prespecified workflow object is to be fetched while initiating the workflow management process.

Once the prespecified workflow object having the proximity within the prespecified threshold is obtained and stored, each of the workflow phase upon implementing may already have the prespecified workflow object that is to be executed during the implementation of the workflow phase. For example, by storing the prespecified workflow object having proximity within the prescribed threshold for the recall investigation phase, when the recall investigation phase is initiated, the prespecified workflow object is preloaded before the recall investigation phase. As a result, the time-consumption in loading of the workflow object and the workflow phase is reduced. The user may immediately be able to execute the workflow phases and quickly complete the workflow management process. Therefore, the present invention may therefore improve the efficiency of the workflow management process.

The present invention thus enables automatic assigning of the desired prespecified workflow object in the workflow phase for facilitating quick and effective workflow management process. With the present invention, workflow objects required for execution of a respective workflow phase may load in the system before the respective workflow phase is initiated. Therefore, one or more workflow phases of the workflow management process may execute in a continuous manner without having any waiting period that may occur due to loading of the workflow objects upon initiating a respective workflow phase from the one or more workflow phases. The present invention may therefore improve the efficiency of the workflow management process. The present invention may enable the user to quickly complete the workflow management process. The present invention may further save computation resources by avoiding repetition of loading of the workflow objects that are common for one or more workflow phases.

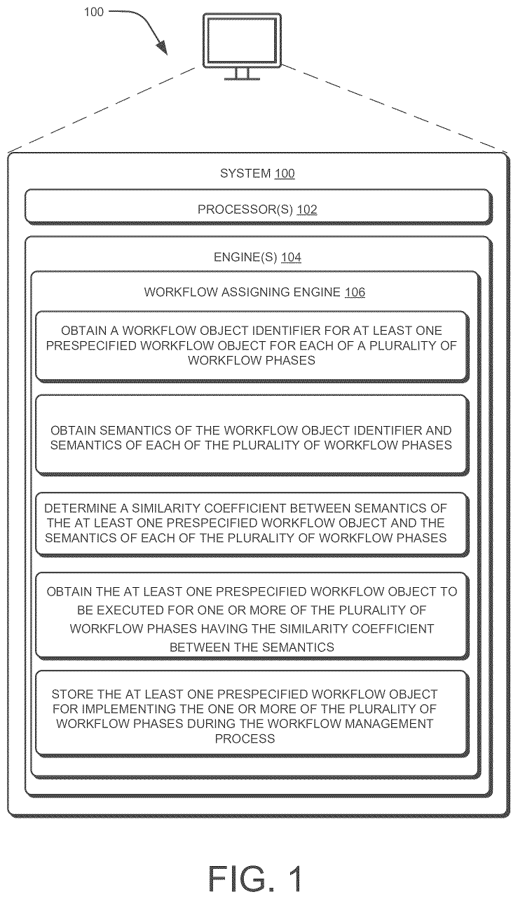

The present subject matter is further described with reference to FIG. 1 to FIG. 9. Wherever possible, the same reference numerals are used in the figures and the following description to refer to the same or similar parts. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a system 100 for workflow management, according to an example. Examples of workflow management may include, but are not limited to, project management workflow, employee onboarding workflow, customer support workflow, marketing campaign workflow, recall management workflow, product quality check workflow. Examples of the system 100 may include, but are not limited to, a laptop, a notebook computer, a server computer, a tablet computer. The system 100 may include processor(s) 102. The processor(s) 102 may include microprocessors, microcomputers, microcontrollers, digital signal processors, central processing units, state machines, logic circuitries, and/or any other devices that manipulate signals and data based on computer-readable instructions. Further, functions of the various elements shown in the figures, including any functional blocks labelled as “processor(s)”, may be provided through the use of dedicated hardware as well as hardware capable of executing computer-readable instructions. In one example, the system 100 may be a standalone server or may be a remote server on a cloud computing platform. In a preferred example, the system 100 may be a cloud-based system. In an example, the system 100 may be communicably coupled to plurality of workflow datasets. Examples of workflow datasets may include, but are not limited to, a laptop, a notebook computer, a server computer, a tablet computer. In an example, the plurality of workflow datasets may be databases that include one or more workflow objects. The workflow objects may represent specific task, process, or entity involved in the workflow. Examples of the workflow objects may include, but are not limited to, set of actions, events, decision point, files, records, reports, and product information. The processor(s) 102, upon executing the workflow management process, may obtain workflow objects as per the user's requirements. For example, upon completion of a product quality check phase for an inventory, the user may obtain workflow objects associated with products that may have not passed the quality check phase.

The system 100 may further include engine(s) 104. The engine(s) 104 may be implemented as a combination of hardware and programming, for example, programmable instructions to implement a variety of functionalities of the engine(s) 104. In examples described herein, such combinations of hardware and programming may be implemented in several different ways. For example, the programming for the engine(s) 104 may be executable instructions. Such instructions may be stored on a non-transitory machine-readable storage medium which may be coupled either directly with the system 100 or indirectly (for example, through networked means). In an example, the engine(s) 104 may include a processing resource, for example, either a single processor or a combination of multiple processors, to execute such instructions. In other examples, the engine(s) 104 may be implemented as electronic circuitry. In an example, the engine(s) 104 may include a workflow assigning engine 106. In an example, the workflow assigning engine 106 may be communicably coupled to a user interface. The user interface may allow interaction of the system 100 with the user.

In an example, upon initiating the system 100, the workflow assigning engine 106 may configure an initial phase. In the initial phase, the workflow assigning engine 106 may obtain the one or more workflow phases required by the user in the workflow management process. In an example, the workflow assigning engine 106 may obtain the workflow phases by receiving a selection of the workflow phases available in the system 100. In another example, the workflow assigning engine 106 may obtain the workflow phases by creating the workflow phases based on a user's input. For example, the user may select the workflow phases from a drop-down menu appearing on the user interface. In another example, the user may create the workflow phases for the workflow management by selecting a new phase in the drop-down menu appearing on the user interface. The user may provide a name of the phase. The created workflow phases may then appear in the drop-down menu for selection.

In an example, upon obtaining the workflow phases, the workflow assigning engine 106 may obtain a prespecified workflow object to be executed for the one or more workflow phases. The workflow objects may represent specific task, process, or entity involved in the workflow. Examples of the workflow objects may include, but are not limited to, set of actions, events, decision point, files, records, reports, and product information. The prespecified workflow object may be fetched from an external database or external server referred to as workflow datasets. For example, a financial dataset may include information related to cost price and selling price of one or more products in an inventory. In an example, the workflow datasets may be stored in one or more workflow repositories as workflow object data.

In an example, the workflow assigning engine 106 may obtain a workflow object identifier for a prespecified workflow object for each of the workflow phases. In an example, the workflow object identifier may be a unique identifier used to reference a specific workflow object. With the workflow object identifier, the processor(s) 102 may distinguish between different workflow instances and their associated tasks, actions, and statuses. Examples of the workflow object identifier may include, but are not limited to, workflow object name, workflow object field name indicating a type of the workflow object, date of creation of workflow object, date of modification of workflow object. For example, the object field name “Medicine” may indicate that the workflow object is related to the medical or healthcare field. In an example, during the initial phase, for each of the workflow phases, the workflow assigning engine 106 may obtain the prespecified workflow object that are desired by the user. The workflow assigning engine 106 may obtain the prespecified workflow object by a user input via the user interface. In an example, the workflow assigning engine 106 may obtain the workflow object identifier for the prespecified workflow object desired by the user, by a user input via the user interface. For example, for a quality investigation phase, the workflow assigning engine 106 may obtain name of a product by a selection input received on a drop-down menu on the user interface showing a one or more product names stored in one or more product datasets. In another example, the workflow assigning engine 106 may obtain names of a products desired by the user, by a text input provided by in an input area of the user interface.

In an example, once the prespecified workflow object and/or the workflow object identifier are obtained, the workflow assigning engine 106 may obtain semantics of the workflow object identifier and the semantics of each of the workflow phases. In an example, semantics may be obtained by using, but is not limited to, semantic annotations approach, latent semantic analysis (LSA), background knowledge graphs approach. Such approaches may attach meaning to words or phrases in a text allowing the processor(s) 102 to understand and process human language. For example, the semantics of “apple” may include its classification as a fruit, its nutritional value, and its cultural significance.

In an example, the semantics of the workflow object identifier and the semantics of each of the workflow phases are parsed through a workflow assigning model to determine a similarity coefficient between semantics of the prespecified workflow object and the semantics of each of the one or more workflow phases. In an example, the workflow assigning model may be an open artificial intelligence-based model. Examples of the workflow assigning model may include, but are not limited to, k-means clustering model, hierarchical clustering model, and Gaussian Mixture Models (GMM). In an example, the parsing of the semantics may comprise transforming context of the at least one prespecified workflow object and context of each of the workflow phases to a high-dimensional vector representing semantic and syntactic characteristics of the contexts. Further, the high-dimensional vector is parsed through a vector space of the workflow assigning model for searching vector embeddings in the vector space close to the high-dimensional vector. Thus, the high-dimensional vector is analysed within the context of the vector space. Further, the workflow assigning model searches for vector embeddings in the vector space that are close to the high-dimensional vector. The term “close” may means that the vectors are similar in terms of their features. In an example, the “closeness” may be measured using a distance metric like Euclidean distance. In an example, the high-dimensional vector may represent a new task. The high-dimensional vector is placed in a vector space where other tasks are already represented as embeddings. The workflow assigning model searches the vector space to find tasks that are similar to the new task represented by the high-dimensional vector. In an example, each prespecified workflow object having similarity coefficient between the semantics is obtained. For example, similarity coefficient may be obtained based on the semantics of the workflow object name and the each of the workflow phases by parsing the semantics through the workflow assigning model. In the workflow assigning model, the semantics may be compared using k-means clustering approach to determine the similarity coefficient. For each of the workflow phases, a prespecified workflow object having the similarity coefficient between the semantics is obtained.

Subsequently, the prespecified workflow object are stored within the system 100. In an example, the prespecified workflow object is stored for implementing one or more workflow phases during the workflow management process. For example, a workflow management process for detecting defective food items in an inventory may involve a food quality check phase and electronic product check phase. The workflow assigning engine 106 may obtain a workflow object identifier “defective food item” from the plurality of workflow datasets storing various food item details. The workflow assigning engine 106 may obtain semantics of the “food quality check” phase and the semantics of the workflow object identifier “defected food item”. The workflow assigning model 106 may determine a similarity coefficient between semantics of the prespecified workflow object and the semantics of each of the workflow phases. For the food quality check phase, a similarity coefficient is obtained between the semantics. Therefore, the prespecified workflow objects, i.e., defected food items from the inventory are stored in the system 100 even before the quality investigation phase is initiated. In an example, the prespecified workflow objects may be stored in the initial phase. Further, for the electronic product check phase, a similarity coefficient between the semantics is not obtained. Therefore, the prespecified workflow objects, i.e., defected food item from the inventory is not obtained for the electronic product check phase.

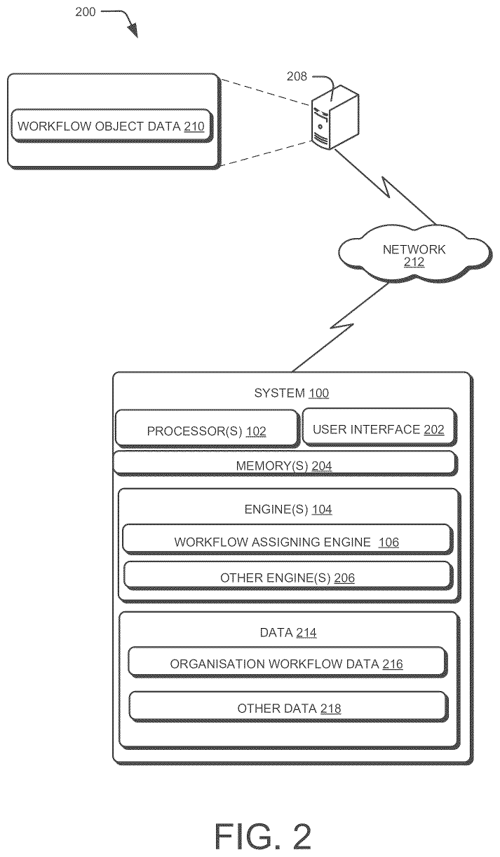

FIG. 2 illustrates a communication environment 200 implementing the system 100 for workflow management, according to an example. The system 100 is described in FIG. 1 and may include, but not limited to, a laptop, a notebook computer, a server computer, a tablet computer, and a smart phone. In addition to the processor(s) 102 and the engine(s) 104, the system 100 further includes user interface 202 and memory(s) 204. The user interface 202 may allow the connection or coupling of the system 100 with the one or more workflow datasets, through a wired (e.g., Local Area Network, i.e., LAN) connection or through a wireless connection (e.g., Bluetooth®, Wi-Fi). The user interface 202 may also enable intercommunication between different logical as well as hardware components of the system 100. The memory(s) 204 may be a computer-readable medium, examples of which include volatile memory (e.g., RAM), and/or non-volatile memory (e.g., Erasable Programmable read-only memory, i.e., EPROM, flash memory, etc.). The memory(s) 204 may be an external memory, or internal memory, such as a flash drive, a compact disk drive, an external hard disk drive, or the like. The memory(s) 208 may further include data which either may be utilized or generated during the operation of the system 100.

In an example, the engine(s) 104, in addition to the workflow assigning engine 106, may include other engine(s) 206. In an example, the other engine(s) 206 may include a workflow configuration engine to configure the initial phase.

In an example, the system 100 may be operated by a user for workflow management. In an example, the user may be an employee of an organization who is handling the workflow management. For example, an employee tracking a specific product that may require recalling from a market. The workflow management may include multiple phases. For example, a recall management process may include a ‘Signal Detection phase’ followed by a ‘Quality investigation phase’ followed by a ‘Recall investigation phase’. Based on the requirements, the user may use different phases of the workflow to obtain various information required to the user. For example, the quality investigation phase may be used for detecting and confirming issues with a product. In another example, the the system 100 may automatically operate the workflow management process upon initiating. In an example, the system 100 may operate on stored inputs in the system 100 by the user.

Initially, in the system 100, one or more workflow phases may be configured as per the user's requirements in the initial phase. In an example, at least one prespecified workflow object may be assigned for one or more of workflow phases. In an example, assigning of the workflow objects may be done by a business administrator. In an example, each of the workflow objects may be associated with one or more datasets including information in relation to workflow object identifier associated with the workflow objects for each of the workflow phases.

In an example, the communication environment 200 may further include one or more workflow repositories 208 that may store the plurality of workflow datasets. In one example, the plurality of workflow datasets may be hosted virtually, for example, on a cloud-based platform at a site or away from the site. In another example, the plurality of workflow datasets may be a stand-alone physical system geographically located either on the site or away from the site. Examples of the site may include, but are not limited to, a building of a company, or any other working environments in any industry or enterprise.

In an example the plurality of workflow datasets may be accessed on the system 100 as a website page. In an example, the plurality of workflow datasets may be accessed by a user, through the system 100, to obtain various workflow objects. Data associated with the workflow objects may be stored in the plurality of workflow datasets for execution of various workflow phases of the workflow management. In an example, the plurality of workflow datasets may store and maintain workflow object data 210 associated with the workflow management process and allow authorized users access to the workflow object data 210.

In an example, the plurality of workflow datasets may be managed and owned by different entities and may be located at different geographical locations. In another example, the plurality of workflow datasets may be managed and owned by the same entities and may be co-located at the same geographical location.

In an example, the system 100 and the one or more workflow repositories 208 may communicably be coupled with each other over a network 212 and may exchange data and signals over the network 212. The network 212 may be a wireless network, a wired network, or a combination thereof. The network 212 may also be an individual network or a collection of many such individual networks, interconnected with each other and functioning as a single large network, e.g., the Internet or an intranet. Examples of such individual networks include, but are not limited to, local area network (LAN), wide area network (WAN), the internet, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN). Depending on the technology, the network 212 may include various network entities, such as transceivers, gateways, and routers. In an example, the network 212 may include any communication network that uses any of the commonly used protocols, for example, Hypertext Transfer Protocol (HTTP), and Transmission Control Protocol/Internet Protocol (TCP/IP). In an example, the one or more workflow repositories 208 of one site may be connected to one or more sites via the network 212.

The system 100 may also include components, other than the depicted components, such as display, input/output interfaces, operating systems, applications, and other software or hardware components (not shown in the figures).

The other engine(s) 206 may be implemented as a combination of hardware and programming, for example, programmable instructions to implement a variety of functionalities of the other engine(s) 206. In examples described herein, such combinations of hardware and programming may be implemented in several different ways. For example, the programming for the other engine(s) 206 may be executable instructions. Such instructions may be stored on a non-transitory machine-readable storage medium which may be coupled either directly with the system 100 or indirectly (for example, through networked means). In an example, other engine(s) 206 may include a processing resource, for example, either a single processor or a combination of multiple processors, to execute such instructions. In the present examples, the non-transitory machine-readable storage medium may store instructions that, when executed by the processing resource, implement the other engine(s) 206. In other examples, the other engine(s) 206 may be implemented as electronic circuitry. In one example, the other engine(s) 206 may perform further implement functionalities that supplement functions performed by the system 100.

The data 214 includes data that is either received, stored, or generated as a result of functions implemented by the system 100. It may be further noted that information stored and available in the data 214 may be utilized by the other engine(s) 206 for performing various functions by the system 100. In an example, the data 214 may include organization workflow data 216 and other data 218. The other data 218 may include data generated by the other engine(s) 206. It may be noted that such examples are only indicative. The present approaches may be applicable to other examples without deviating from the scope of the present subject matter. The organization workflow data 216 may be defined as workflow object data 210 obtained from the one or more workflow repositories 208, including data such as sales data, and products data, associated with the organization. In an example, the organization workflow data 216 may also include data obtained or modified from the workflow object data 210 upon implementation of the workflow phases in the workflow management process. In an example, the organization workflow data 216 may be stored in the form of one of more datasets in the system 100 which may be utilized for workflow management.

While configuring the workflow phases in the initial phase, the workflow assigning engine 106 may obtain a workflow object identifier for at least one prespecified workflow object for each of the workflow phases. In another example, the workflow assigning engine 106 may obtain one or more workflow object identifier for at least one prespecified workflow object for each of the workflow phases. For example, the workflow assigning engine 106 may obtain the field name “fruit” for an object “apple” from the workflow datasets stored in one or more workflow repositories 208.

In an example, once the workflow object identifier is obtained, semantics of the workflow object identifier and the semantics of each of the workflow phases are obtained. In an example, semantics of a workflow object identifier may define meaning and purpose of identifiers used to track workflow objects. In an example, the semantics may be obtained using semantic annotations approach. In another example, the semantics may be obtained using a Machine learning approach. In an example, the workflow assigning engine 106 may parse the semantics of the workflow object identifier and the semantics of each of the workflow phases through a workflow assigning model to determine a similarity coefficient between semantics of the at least one prespecified workflow object and the semantics of each of the workflow phases. In an example, the workflow assigning model may use the similarity coefficients to determine the closest and most suitable phases for the workflow object. In an example, the workflow assigning model may be an open artificial intelligence-based model. In an example, the workflow assigning model may be k-means clustering model. In the parsing of semantics, context of the at least one prespecified workflow object and context of each of the workflow phases are transformed to a high-dimensional vector representing semantic and syntactic characteristics of the contexts. The high-dimensional vector may then be parsed through a vector space of the workflow assigning model for searching vector embeddings in the vector space close to the high-dimensional vector. In an example, each prespecified workflow object having similarity coefficient between the semantics is obtained. For example, similarity coefficient may be obtained based on the semantics of the workflow object name and the each of the workflow phases by parsing the semantics through the workflow assigning model. In the workflow assigning model, the semantics may be compared using k-means clustering approach to determine the similarity coefficient. For each of the workflow phases, a prespecified workflow object having the similarity coefficient between the semantics is obtained. The prespecified workflow object is stored for implementing the workflow phases during the workflow management process. In an example, the prespecified workflow object may be stored in the memory(s) 204 of the system 100 as the organization workflow data 216. In an example, the workflow object identifier associated with the prespecified workflow object may be stored in the memory(s) 204 of the system 100 as other data 218. In an example, the other data 218 may include the prespecified characteristics associated with the prespecified workflow objects.

For example, a workflow management process for detecting defective goods in an inventory may involve a quality investigation phase. During the initial phase, the workflow assigning engine 106 may obtain workflow object identifier “defected product” from the workflow datasets having product details. The workflow assigning engine 106 may obtain semantics of the quality investigation phase and the semantics of the workflow object identifier “defected product”. The workflow assigning model may determine a similarity coefficient between semantics of the at least one prespecified workflow object and the semantics of each of the workflow phases. For the quality investigation phase, a similarity coefficient is obtained between the semantics. Therefore, prespecified workflow object, i.e., defected products from the inventory are stored in the system 100 even before the quality investigation phase is initiated. As a result, upon executing the quality investigation phase, the user interface 202 is loaded with the prespecified workflow object immediately. This reduces the waiting time period for the user. The user is provided with a quick and effective workflow management approach in which the workflow objects are assigned automatically in the workflow phases. Further, lesser amount of data resource is exchanged in the process since the workflow objects associated with the workflow phases are loaded at one go. Thus, loading of workflow objects at every phase in the workflow is avoided.

In another embodiment of the present subject matter, while the workflow phases in the workflow management process are being configured, the workflow assigning engine 106 may obtain a prespecified workflow object from one or more workflow datasets stored in one or more workflow repositories 208 for each of the workflow phases. In an example, the workflow assigning engine 106 may obtain a workflow object metadata associated with the prespecified workflow object and a workflow phase metadata for each of the one or more workflow phases are generated. In an example, metadata describes meanings of the workflow object and the workflow phase. In an example, the workflow object metadata with the workflow phase metadata for each of the one or more workflow phases are compared to determine the proximity of the prespecified workflow object with each of the workflow phases. The proximity may define how closely the prespecified workflow object is related to a respective workflow phase of the workflow phases. For example, the workflow phase “medical device detection” and the prespecified workflow object “Blood pressure measuring device” may have a different proximity in comparison to a proximity of the workflow phase “medical device detection” and the prespecified workflow object “computing device”. In another example, the proximity may be defined as the distance between a respective workflow phase and the prespecified workflow object.

In an example, the proximity of the prespecified workflow object is determined with each of the workflow phases to be within a prespecified threshold. In an example, a value may be provided by the user as the threshold. For example, the user may provide 5% of the proximity as the threshold value. Therefore, all the prespecified workflow objects within the value of 5% will be stored in the system for the respective workflow phase. In another example, machine learning algorithm may dynamically adjust the threshold based on continuous learning from new data.

Upon determining that the proximity is within the prespecified threshold, the workflow assigning engine 106 may obtain the prespecified workflow object having the proximity in the prespecified threshold. In an example, the workflow assigning engine 106 may store the prespecified workflow object for implementation of a respective workflow phase from among the workflow phases in the workflow management process. The stored prespecified workflow object may be fetched while initiating the workflow management process. Therefore, one or more workflow phases may obtain the prespecified workflow object having proximity within the prespecified threshold. For example, a workflow phase A and a workflow phase B may require a prespecified workflow object. Further, the workflow phase B that is to be initiated after the execution of the workflow phase A. When the proximity between the prespecified workflow object with the workflow phase A and proximity between the prespecified workflow object with the workflow phase B is within the prespecified threshold. The workflow assigning engine 106 will obtain the prespecified workflow object for both, i.e., the workflow phase A and the workflow phase B. Thus, the prespecified workflow object will be ready for execution upon initiation of the workflow phase B and is not required to be loaded after the initiation of the workflow phase B.

As a result, loading time of the workflow object is reduced since the workflow objects determined for each of the workflow phases to be within the prespecified threshold may load before the initiation of the respective workflow phase. The user may therefore be able to execute the workflow phases immediately and quickly complete the workflow management process. This improves the efficiency of the workflow management process.

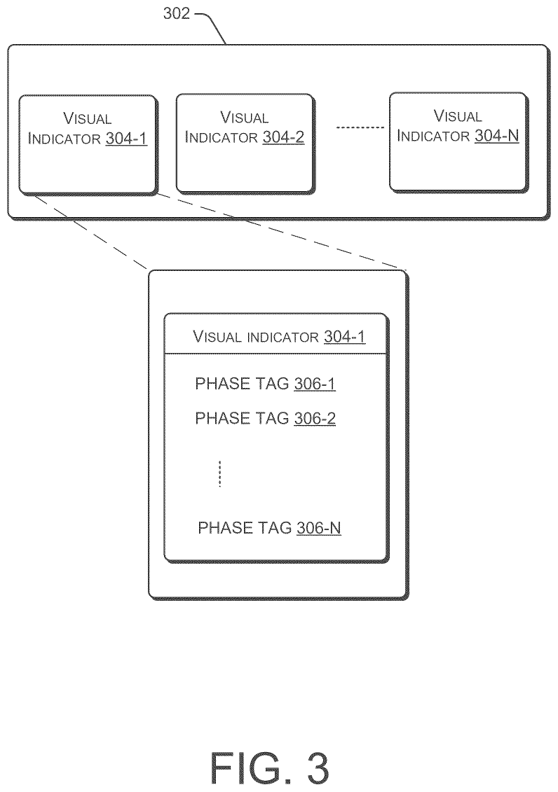

FIG. 3 illustrates a schematic representation of a user interface 302 as per a first layout, according to an example. In an example, the user interface 302 of the first layout is similar to the user interface 202 and is operated under the control of the system 100 and its components. In an example, the user interface 302 may be presented to a user of an organization upon initiating the system 100 as the first layout. In an example, the workflow assigning engine 106 may obtain the one or more workflow phases for the workflow process based on the user input received via the user interface 302. In an example, the user interface 302 may include one or more visual indicators 304-1, 304-2, . . . 304-N and one or more phase tags 306-1, 306-2, . . . 306-N. Here, N may be greater than or equal to 1. The one or more visual indicators 304-1, 304-2, . . . 304-N may be collectively referred to as visual indicators 304 and individually as visual indicator 304. The one or more phase tags 306-1, 306-2, . . . 306-N may be collectively referred to as phase tags 306 and individually as phase tag 306. The user interface 302 may also include components or icons other than the depicted component.

In an example, the visual indicators 304 may be particular visual indicators which are provided to the user by the user interface 302. In an example, each corresponding visual indicator 304 may be associated with a corresponding phase tag 306. In another example, each corresponding visual indicator 304 may be associated with one or more phase tags 306. Each of the phase tags 306 may represent one of the workflow phases from the workflow datasets stored in one or more workflow repositories 208. Upon selection of a respective phase tag 306, a respective workflow phase associated with the phase tag 306 may be obtained by the workflow assigning engine 106. In another example, the user interface 302 may comprise a dashboard in which the visual indictors 304 are shown. Each of the visual indictors 304 is a drag-drop menu. Upon selecting the visual indicator 304, the phase tags 306 may appear in a list in the drag-drop menu. The workflow assigning engine 106 may obtain the workflow phases based on the selection of one or more phase tags 306 from the phase tags 306. In another example, the visual indicator 304 may include a new phase tag which upon selection allows user to create a new workflow phase. The new workflow phase may then be stored in the memory(s) 204 of the system 100. In another example, the new workflow phase may be stored in one or more workflow repositories 208.

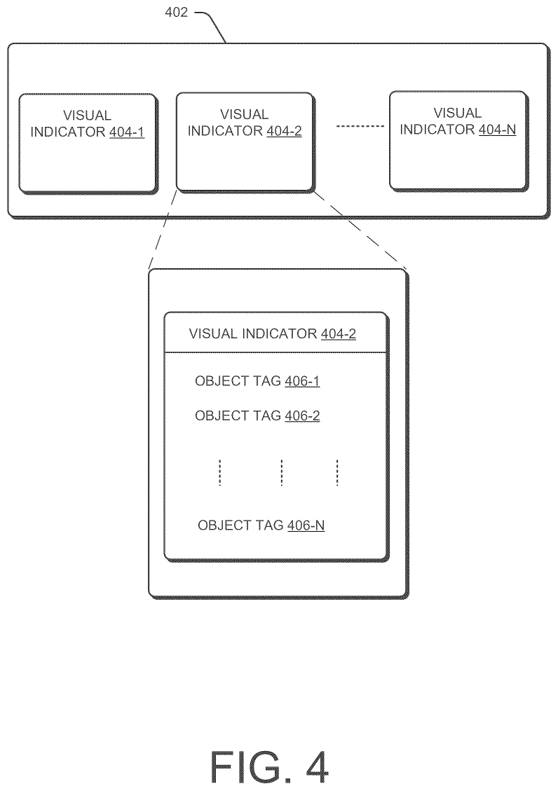

FIG. 4 illustrates a schematic representation of a user interface 402 as per a second layout, according to an example. In an example, the user interface 402 is similar to the user interface 202 and is operated under the control of the system 100 and its components. In an example, the user interface 402 may be presented to the user of the organization as the second layout. In an example, the workflow assigning engine 106 may obtain the prespecified workflow object for the workflow phases based on user inputs received via the user interface 402. In an example, the user interface 402 may include one or more visual indicators 404-1, 404-2, . . . 404-N and one or more object tags 406-1, 406-2, . . . 406-N. Here, N may be greater than or equal to 1. The one or more visual indicators 404-1, 404-2, . . . 404-N may be collectively referred to as visual indicators 404 and individually as visual indicator 404. The one or more object tags 406-1, 406-2, . . . 406-N may be collectively referred to as object tags 406 and individually as object tag 406. The user interface 402 may also include components or icons other than the depicted component.

In an example, the visual indicators 404 may be particular visual indicators which are provided to the user by the user interface 402. In an example, each corresponding visual indicator 404 may be associated with a corresponding object tag 406. In another example, each corresponding visual indicator 404 may be associated with one or more object tags 406. Each of the object tags 406 may represent the prespecified workflow object from the workflow datasets stored in one or more workflow repositories 208. Upon selection of a respective object tag 406, a respective prespecified workflow object associated with the object tag 406 may be obtained by the workflow assigning engine 106. In another example, the user interface 402 may comprise a dashboard in which the visual indictors 404 are shown. Each of the visual indictors 404 is a drag-drop menu. Upon selecting the visual indicator 404, the object tags 406 may appear in a list in the drag-drop menu. The workflow assigning engine 106 may obtain the object tags 406 based on the selection, by the user, of one or more objects tags 406 from the drop-down menu. In another example, the object tag 406 may comprise an object filter tag that may obtain the prespecified workflow object from the dataset stored in the one or more workflow repositories 208 based on the workflow object identifier based on the user input. For example, upon selecting a workflow object identifier of “last three years products”, the workflow assigning engine 106 may obtain prespecified workflow objects associated with the products from the last three years. Similarly, by an object filter tag of “products of last three days”, the workflow assigning engine 106 may obtain prespecified workflow objects associated with the products from last three days.

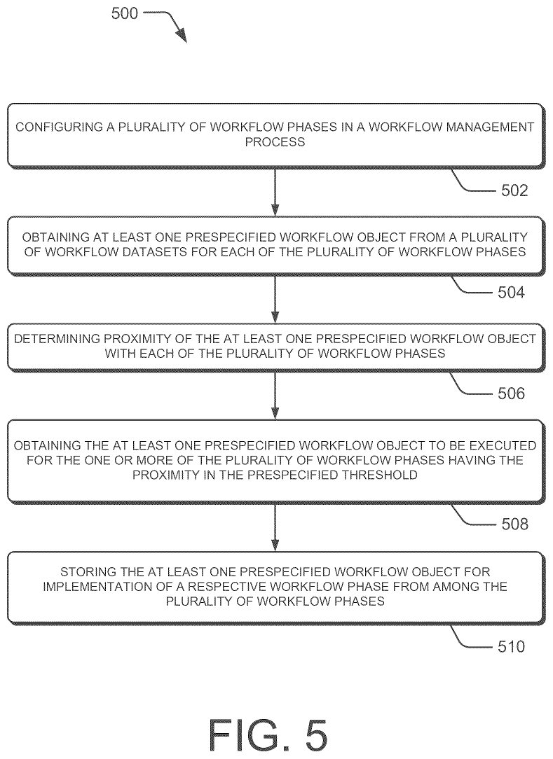

FIG. 5 illustrates example method 500 for implementation of workflow management, according to an example. The order in which the method is described is not intended to be construed as a limitation, and any number of the described method blocks may be combined in any order to implement the method, or an alternative method. Further, the method 500 may be implemented by processing resource or computing device(s) through any suitable hardware, non-transitory machine-readable instructions, or combination thereof.

It may also be understood that method 500 may be performed by programmed computing devices, such as the system 100, as depicted in FIG. 1 and FIG. 2. Furthermore, the method 500 may be executed based on instructions stored in a non-transitory computer-readable medium, as will be readily understood. The non-transitory computer-readable medium may include, for example, digital memories, magnetic storage media, such as one or more magnetic disks and magnetic tapes, hard drives, or optically readable digital data storage media. While the method 500 is described below with reference to the system 100 as described above, other suitable systems for the execution of these methods may also be utilized. Additionally, implementation of these methods is not limited to such examples.

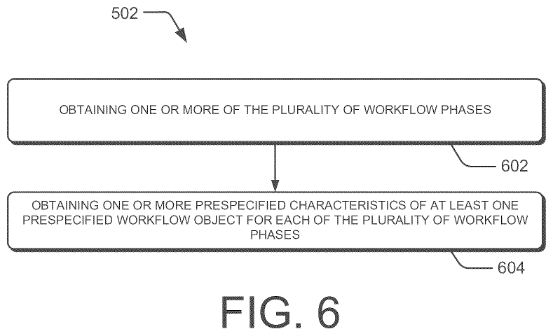

At block 502, a plurality of workflow phases in a workflow management process are configured. The block 502 is further explained with reference to FIG. 6. FIG. 6 illustrates configuring the plurality of workflow phases in the management process, according to an example. At block 602, one or more workflow phases are obtained. In an example, the workflow phases may be obtained from workflow datasets stored in one or more workflow repositories 208, based on a selection user input on the user interface 202. In an example, the user may select the workflow phases from a drag-drop menu shown on the user interface 202.

At block 604, prespecified characteristics of a prespecified workflow object are obtained for each of the workflow phases. The prespecified workflow object may be implemented based on the prespecified characteristics. The prespecified characteristics are associated with applicability of the prespecified workflow object on the workflow phases. In an example, the prespecified characteristics may include at least one of a workflow object name, a workflow object field name indicating a type of the workflow object, a workflow object number indicating a serial number of the workflow object, a workflow object date indicating a date of creation of the workflow object, and a workflow object modification date indicating a date of modification of the workflow object. For example, a medicine may have prespecified characteristics such as type of medicine, manufacturer of the medicine, date of expiry. The prespecified workflow objects and the prespecified characteristics associated with the prespecified workflow objects may be stored in the workflow datasets in one or more workflow repositories 208. In an example, the prespecified characteristics associated with the prespecified workflow objects may be stored as workflow object characteristics data.

Returning to FIG. 5, at block 504, the prespecified workflow object is obtained from the workflow datasets for each of the workflow phases. In an example, the prespecified workflow object is obtained based on a user-based selection via the user interface 202.

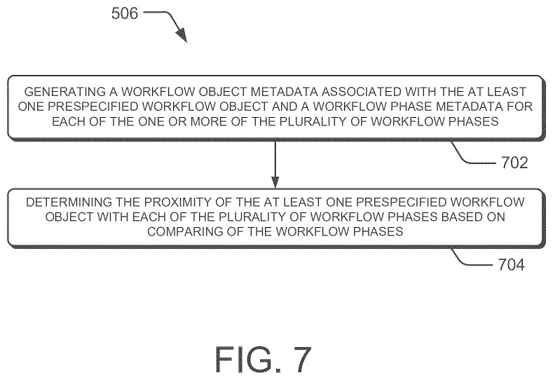

At block 506, a proximity of the prespecified workflow object with each of the workflow phases is determined. The block 506 is further explained with the refence to FIG. 7. FIG. 7 illustrates determining proximity of the prespecified workflow object from the one or more workflow phases in the workflow management process, according to an example. At block 702, a workflow object metadata associated with the prespecified workflow object and a workflow phase metadata for each of the workflow phases are generated.

At block 704, the workflow object metadata with the workflow phase metadata for each of the workflow phases are compared. Based on the comparing of the workflow object metadata and each of the workflow phases, the proximity of the prespecified workflow object with each of the workflow phases is determined. For example, a workflow process may include two workflow phases, i.e., a workflow phase 1 and a workflow phase 2. The prespecified workflow object is obtained from workflow datasets for each of two the workflow phases. Further, a workflow object metadata associated with the prespecified workflow object and a workflow phase metadata for the workflow phase 1 and the workflow phase 2 are generated. The workflow object metadata is compared with the workflow phase metadata of workflow phase 1 and the workflow phase 2.

Returning to FIG. 5, at block 506, the proximity between the prespecified workflow object and the workflow phases is determined to be in a prespecified threshold. At block 508, upon determining the proximity to be within the prespecified threshold, the prespecified workflow object to be executed for the workflow phases are obtained.

At block 510, the prespecified workflow object is stored in the memory(s) 204 of the system 100 for implementation of a respective workflow phase from among the workflow phases. In another example, the prespecified workflow object is stored in the workflow datasets stored of the one or more workflow repositories 208. In an example, the prespecified workflow object is to be fetched while initiating the workflow management process.

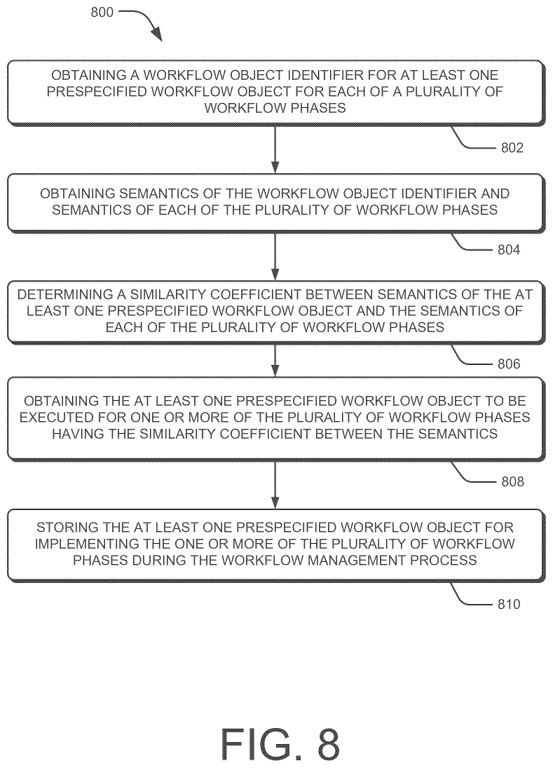

FIG. 8 illustrates the method 800 for implementation of workflow management, according to another example. The order in which the method is described is not intended to be construed as a limitation, and any number of the described method blocks may be combined in any order to implement the method, or an alternative method. Similar to method 500, the method 800 may be implemented by processing resource or computing device(s) through any suitable hardware, non-transitory machine-readable instructions, or combination thereof. Further, the method 800 may be performed by programmed computing devices, such as the system 100, as depicted in FIG. 1 and FIG. 2. The method 800 may be executed based on instructions stored in a non-transitory computer-readable medium, as will be readily understood. The non-transitory computer-readable medium may include, for example, digital memories, magnetic storage media, such as one or more magnetic disks and magnetic tapes, hard drives, or optically readable digital data storage media. While the method 800 is described below with reference to the system 100 as described above, other suitable systems for the execution of these methods may also be utilized. Additionally, implementation of these methods is not limited to such examples.

At block 802, a workflow object identifier for at least one prespecified workflow object is obtained for each of one or more workflow phases. In another example, one or more workflow object identifiers for at least one prespecified workflow object are obtained. The prespecified workflow object is to implement a respective workflow phase from among the workflow phases in a workflow management process. In an example, the workflow phases of the workflow management process are set up in an initial phase of the workflow management process. In an example, an initial phase is configured by a workflow configuration engine of the system 100. The initial phase is configured to set up the workflow phases in the workflow management process. In an example, workflow datasets are obtained for each of the workflow phases. The workflow datasets include one prespecified workflow object for one or more of the workflow phases.

At block 804, semantics of the workflow object identifier and semantics of each of the workflow phases are obtained. In an example, the semantics of the workflow object identifier and for each of the workflow phases may be obtained using various semantics approaches. Examples of semantics approaches may include, but are not limited to, semantics annotation approach and latent semantic analysis (LSA), machine learning models, hierarchical clustering, background knowledge graphs. For example, a semantic of an employee name may be obtained as numerical value using a semantic approach. In an example, context of the at least one prespecified workflow object and context of each of the workflow phases are transformed to a high-dimensional vector representing semantic and syntactic characteristics of the contexts. In an example, the high-dimensional vector is parsed through a vector space of the workflow assigning model for searching vector embeddings in the vector space close to the high-dimensional vector.

At block 806, the semantics of the workflow object identifier and the semantics of each of the workflow phases are parsed through a workflow assigning model to determine a similarity coefficient between semantics of the at least one prespecified workflow object and the semantics of each of the workflow phases. In an example, the similarity coefficient may quantify how closely related or similar the meanings of the workflow object identifier and the workflow phase are. In an example, the workflow assigning model is an open artificial intelligence-based model. In another example, the workflow assigning model is a k-means clustering model. For example, upon obtaining numerical values as the semantics of the workflow object identifier and the semantics of each of the workflow phases, the workflow assigning model may determine a similarity coefficient between semantics of the at least one prespecified workflow object and the semantics of each of the workflow phases. When the similarity coefficient is between the semantics of the at least one prespecified workflow object and the semantics of a workflow phase from the workflow phases, the at least one prespecified workflow object may be considered as closely related to the respective workflow phase.

At block 808, the at least one prespecified workflow object to be executed for one or more of the workflow phases having the similarity coefficient between the semantics is obtained. For example, a similarity coefficient for semantics of a first-year employee names of an organization and semantics of a phase of employee detail investigation phase may be in between the semantics. In another situation a similarity coefficient for semantics of employers and semantics of the phase of employee detail investigation phase may not be in between the semantics. As a result, only the first year employees name as the at least one prespecified workflow object are obtained.

At block 810, the at least one prespecified workflow object are stored for implementing the one or more of the workflow phases during the workflow management process. In an example, the at least one prespecified workflow object may be stored in the memory(s) 204 of the system 100 as organization workflow data 216. In another example, the at least one prespecified workflow object may be stored in one of the datasets stored in the one or more workflow repository(s) 208 as the workflow object data 210. In an example, the at least one prespecified workflow object is to be fetched while initiating the workflow management process. In an example, while configuring the initial phase, the at least one prespecified workflow object to be executed for the one or more of the workflow phases having the similarity coefficient between the semantics is obtained.

With the prespecified workflow objects stored in the system 100 for the respective workflow phase, upon initiating the respective workflow phase, the prespecified workflow objects may instantly load on the user interface 202. Thus, the user is provided with an efficient workflow process in which phase loading time for each phase of the workflow is reduced.

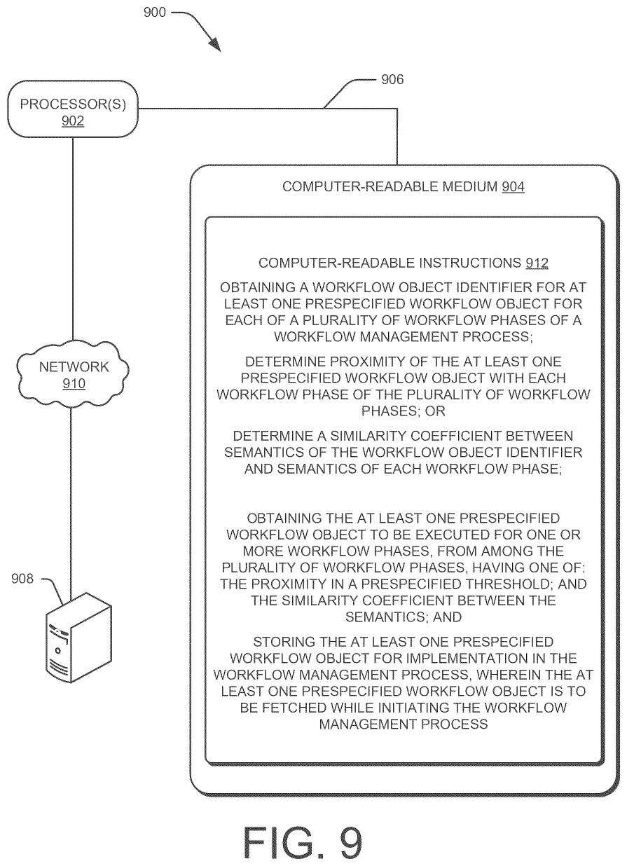

FIG. 9 illustrates a computing environment 900 implementing a non-transitory computer-readable medium for a workflow management process, according to an example. In an example, the computing environment 900 includes processor(s) 902 communicatively coupled to a non-transitory computer-readable medium 904 through a communication link 906. In one example, the communication link 906 may be similar to the network 212, as described in conjunction with the preceding figures. In an example implementation, the computing environment 900 may be for example, the communication environment 200. In an example, the processor(s) 902 may have one or more processing resources for fetching and executing computer-readable instructions from the non-transitory computer-readable medium 904. The processor(s) 902 and the non-transitory computer-readable medium 904 may be implemented, for example, in the system 100 (as has been described in conjunction with the preceding figures).

The non-transitory computer-readable medium 904 may be, for example, an internal memory device or an external memory device. In an example implementation, the communication link 906 may be a network communication link. The processor(s) 902 and the non-transitory computer-readable medium 904 may also be communicatively coupled to one or more servers 908 over a network 910. The one or more servers 908 may be the workflow repository 208 as described in conjunction with FIG. 2. The network 910 may similar to the network 212 described in conjunction with FIG. 2.

In an example implementation, the non-transitory computer-readable medium 904 may include a set of computer-readable instructions 912 which may be accessed by the processor(s) 902 through the communication link 906. Referring to FIG. 9, in an example, the non-transitory computer-readable medium 904 may include instructions 912 that may cause the processor(s) 902 to obtain a workflow object identifier for at least one prespecified workflow object for each of a plurality of workflow phases of the workflow management process. In an example, the prespecified workflow object, workflow object identifier, and workflow phases are the prespecified workflow object, workflow object identifier, and workflow phases described in conjunction with the preceding figures. The at least one prespecified workflow object is to implement a respective workflow phase from among the plurality of workflow phases. Subsequently, the instructions 912 may cause the processor(s) 902 to determine one of: proximity of the at least one prespecified workflow object with each workflow phase of the plurality of workflow phases, and a similarity coefficient between semantics of the workflow object identifier and semantics of each workflow phase. In an example, the proximity of the at least one prespecified workflow object with each workflow phase of the plurality of workflow phases is the proximity described in conjunction with the preceding figures. In an example, the determination of proximity may involve transforming context of the at least one prespecified workflow object and context of each of the plurality of workflow phases to a high-dimensional vector representing semantic and syntactic characteristics of the contexts. Further, the the high-dimensional vector is parsed through a vector space of the workflow assigning model for searching vector embeddings in the vector space close to the high-dimensional vector. Similarly, the similar coefficient determined to between semantics of the workflow object identifier and semantics of each workflow phase is the similar coefficient described in conjunction with the preceding figures. In an example, the similarity coefficient is determined by parsing the semantics of the workflow object identifier and the semantics of each of the plurality of workflow phases through a workflow assigning model. In an example, the workflow assigning model is a K-means clustering model.

The instructions 912 may further cause the processor(s) 902 to obtain the at least one prespecified workflow object to be executed for one or more workflow phases, from among the plurality of workflow phases, upon having one of the proximity in a prespecified threshold and the similarity coefficient between the semantics. Once the at least one prespecified workflow object are obtained, the instructions 912 may further cause the processor(s) 902 to store the at least one prespecified workflow object for implementation in the workflow management process. The at least one prespecified workflow object is to be fetched while initiating the workflow management process.

While determining the proximity, a workflow object metadata associated with the at least one prespecified workflow object and a workflow phase metadata for each of the one or more of the plurality of workflow phases are generated as described in conjunction with the preceding figures. Further, the workflow object metadata with the workflow phase metadata for each of the one or more of the plurality of workflow phases are compared to determine the proximity of the at least one prespecified workflow object with each of the plurality of workflow phases. The present invention thus enables automatic assigning of the desired prespecified workflow object in the workflow phase for facilitating quick and effective workflow management process

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

1. A system comprising:
a workflow assigning engine to:
obtain a workflow object identifier for at least one prespecified workflow object for each of a plurality of workflow phases, wherein the at least one prespecified workflow object is to implement a respective workflow phase from among the plurality of workflow phases in a workflow management process;
obtain semantics of the workflow object identifier and semantics of each of the plurality of workflow phases;
parse the semantics of the workflow object identifier and the semantics of each of the plurality of workflow phases through a workflow assigning model to determine a similarity coefficient between semantics of the at least one prespecified workflow object and the semantics of each of the plurality of workflow phases;
obtain the at least one prespecified workflow object to be executed for one or more of the plurality of workflow phases having the similarity coefficient between the semantics; and
store the at least one prespecified workflow object for implementing the one or more of the plurality of workflow phases during the workflow management process, wherein the at least one prespecified workflow object is to be fetched while initiating the workflow management process.

2. The system as claimed in claim 1, further comprising:
a workflow configuration engine to:
configure an initial phase to set up the plurality of workflow phases in the workflow management process; and
obtain a plurality of workflow datasets for each of the workflow phases, wherein each of the plurality of workflow datasets comprises the at least one prespecified workflow object for one or more of the plurality of workflow phases.

3. The system as claimed in claim 2, wherein the workflow configuration engine is to:
while configuring the initial phase, obtain the at least one prespecified workflow object to be executed for the one or more of the plurality of workflow phases having the similarity coefficient between the semantics.

4. The system as claimed in claim 1, wherein the parsing of the semantics of the workflow object identifier and the semantics of each of the plurality of workflow phases through the workflow assigning model comprises:
transforming context of the at least one prespecified workflow object and context of each of the plurality of workflow phases to a high-dimensional vector representing semantic and syntactic characteristics of the contexts; and
parsing the high-dimensional vector through a vector space of the workflow assigning model for searching vector embeddings in the vector space close to the high-dimensional vector.

5. The system as claimed in claim 1, wherein the workflow assigning model is an open artificial intelligence based model.

6. The system as claimed in claim 1, wherein the workflow assigning model is a k-means clustering model.

7. The system as claimed in claim 1, wherein the workflow object identifier comprises one or more of a pre-stored workflow object name and pre-stored workflow object field names, each of the pre-stored workflow object field names indicates a type of the at least one prespecified workflow object.

8. The system as claimed in claim 2, wherein the plurality of workflow datasets is stored in one or more workflow repositories as workflow object data.

9. A method comprising:
configuring a plurality of workflow phases in a workflow management process;
obtaining at least one prespecified workflow object from a plurality of workflow datasets for each of the plurality of workflow phases, wherein the at least one prespecified workflow object is to implement a respective workflow phase from among the plurality of workflow phases in the workflow management process;
determining proximity of the at least one prespecified workflow object with each of the plurality of workflow phases;
on determining the proximity between the at least one prespecified workflow object and one or more of the plurality of workflow phases in a prespecified threshold, obtaining the at least one prespecified workflow object to be executed for the one or more of the plurality of workflow phases having the proximity in the prespecified threshold; and
storing the at least one prespecified workflow object for implementation of a respective workflow phase from among the plurality of workflow phases, wherein the at least one prespecified workflow object is to be fetched while initiating the workflow management process.

10. The method as claimed in claim 9, further comprising:
generating a workflow object metadata associated with the at least one prespecified workflow object and a workflow phase metadata for each of the one or more of the plurality of workflow phases; and
comparing the workflow object metadata with the workflow phase metadata for each of the one or more of the plurality of workflow phases to determine the proximity of the at least one prespecified workflow object with each of the plurality of workflow phases.

11. The method as claimed in claim 9, further comprising storing the plurality of workflow datasets in one or more workflow repositories as workflow object data.

12. The method as claimed in claim 9, further comprising:
obtaining one or more prespecified characteristics of the at least one prespecified workflow object, wherein the one or more prespecified characteristics are associated with applicability of the at least one prespecified workflow object on one or more of the plurality of workflow phases; and
obtaining the one or more of the plurality of workflow phases on which the at least one prespecified workflow object is to be implemented based on the one or more prespecified characteristics.

13. The method as claimed in claim 12, wherein the one or more prespecified characteristics comprises at least one of:
a workflow object name;
a workflow object field name indicating a type of the workflow object;
a workflow object number indicating a serial number of the workflow object;
a workflow object date indicating a date of creation of the workflow object; and
a workflow object modification date indicating a date of modification of the workflow object.

14. The method as claimed in claim 9, further comprising:
configuring an initial phase to set up the plurality of workflow phases in the workflow management process; and
while configuring the initial phase, obtaining the at least one prespecified workflow object to be executed for the one or more of the plurality of workflow phases having the proximity in the prespecified threshold.

15. The method as claimed in claim 12, further comprising storing the one or more prespecified characteristics in one or more workflow repositories as workflow object characteristics data.

16. A non-transitory computer-readable medium having instructions stored thereon, the instructions, when executed by a processor, cause the processor to perform operations comprising:
obtaining a workflow object identifier for at least one prespecified workflow object for each of a plurality of workflow phases of a workflow management process, wherein the at least one prespecified workflow object is to implement a respective workflow phase from among the plurality of workflow phases;
determining one of:
proximity of the at least one prespecified workflow object with each workflow phase of the plurality of workflow phases; and
a similarity coefficient between semantics of the workflow object identifier and semantics of each workflow phase;
obtaining the at least one prespecified workflow object to be executed for one or more workflow phases, from among the plurality of workflow phases, having one of:
the proximity in a prespecified threshold; and
the similarity coefficient between the semantics; and
storing the at least one prespecified workflow object for implementation in the workflow management process, wherein the at least one prespecified workflow object is to be fetched while initiating the workflow management process.

17. The non-transitory computer-readable medium as claimed in claim 16, further comprising:
parsing the semantics of the workflow object identifier and the semantics of each of the plurality of workflow phases through a workflow assigning model to determine the similarity coefficient between semantics of the at least one prespecified workflow object and the semantics of each of the plurality of workflow phases.

18. The non-transitory computer-readable medium as claimed in claim 17, further comprising:
transforming context of the at least one prespecified workflow object and context of each of the plurality of workflow phases to a high-dimensional vector representing semantic and syntactic characteristics of the contexts; and
parsing the high-dimensional vector through a vector space of the workflow assigning model for searching vector embeddings in the vector space close to the high-dimensional vector.

19. The non-transitory computer-readable medium as claimed in claim 16, further comprising:
generating a workflow object metadata associated with the at least one prespecified workflow object and a workflow phase metadata for each of the one or more of the plurality of workflow phases; and
comparing the workflow object metadata with the workflow phase metadata for each of the one or more of the plurality of workflow phases to determine the proximity of the at least one prespecified workflow object with each of the plurality of workflow phases.

20. The non-transitory computer-readable medium as claimed in claim 17, wherein the workflow assigning model is a k-means clustering model.
